(19) United States
(12) Patent Application Publication
(10) Pub. No.: US 2009/0144446 A1
(43) Pub. Date: Jun. 4, 2009

(54) Remediation management for a network with multiple clients

(76) Inventors: Joseph Olakangil, Midvale, UT (US); Paramesh Kailasam, Los Angeles, CA (US); Robert L. Sangroniz, Cottonwood Heights, UT (US); Laurence Rose, Oak Park, CA (US); L. Michele Goodwin, Westlake Village, CA (US); Jonathan Wong, Alhambra, CA (US); Sahil Dighe, Salt Lake City, UT (US); David Morgan, Salt Lake City, UT (US); Stephen Clawson, Salt Lake City, UT (US)

Correspondence Address: PATTI , HEWITT & AREZINA LLC, ONE NORTH LASALLE STREET, 44TH FLOOR, CHICAGO, IL, 60602, US

(21) Appl. No.: 11/998,346

(22) Filed: Nov. 29, 2007

(51) Int. Cl. G06F 15/173

(52) U.S. Cl. 709/239

(57) ABSTRACT

An exemplary method directs client devices client devices in a computing network to a remediation node. A subset of the client devices to receives remediation services is identified with a single common label. Upon determining that one of the client devices originating a communication request packet is identified by the single common label, processing the communication request packet by routing the communication request packet to a redirection server, and transmitting from the redirection server to the one client device a hypertext transfer protocol (HTTP) command specifying that the one client device redirect communications to the remediation node so that remediation services can be supplied to the one client device via the remediation node.

### BACKGROUND

This invention relates to remediation management and control by a switch for a plurality of served client devices. As used herein remediation refers to the need for client devices to receive a software update or to have a virus infection or the like neutralized. This invention is especially, but not exclusively, suited for remediation management for a segregated group of clients such as in a corporate or university local area network (LAN) of clients.

Various ways have been utilized to provide remediation for clients in a network. In a typical example, a group of clients in a corporate LAN is provided with a variety of services including access to the Internet. Despite security measures to minimize the risk of clients contracting a virus or other infecting agents, one or a subgroup of clients may become infected. A person in charge of administering the corporate LAN can manually enter the identity of each of the infected clients at the switch through which the clients' TCP/IP communications are processed in order to restrict infected client communications to only a designated server that can provide assistance in neutralizing the infection. However, such a solution requires the intervention of the administrator. Further, processing of the identities (individual client addresses) of the infected clients at a control switching node adversely impacts its handling capacity in view of the additional processing burden placed on it by having to screen access requests to determine if the request is made by an infected client. Also storage of each of the client addresses of the infected clients at a control switching node may be limited due to the amount of memory capacity of the responsible switching element. A requirement for specific clients to download software updates results in similar burdens and disadvantages since the identity of the specific clients have to be entered into the control communication switch and processed in a similar manner. Thus, a need exists for an improved remediation process.

### SUMMARY

It is an object of the present invention to satisfy this need.

An exemplary method directs client devices in a computing network to a remediation node. A subset of the client devices to receive remediation services is identified with a single common label. Upon determining that one of the client devices originating a communication request packet is identified by the single common label, processing the communication request packet by routing the communication request packet to a redirection server, and transmitting from the redirection server to the one client device a hypertext transfer protocol (HTTP) command specifying that the one client device redirect communications to the remediation node so that remediation services can be supplied to the one client device via the remediation node.

An exemplary switch in accord with the present invention implements the above method.

### DESCRIPTION OF THE DRAWINGS

Features of exemplary implementations of the invention will become apparent from the description, the claims, and the accompanying drawings in which:

FIG. 1 is a block diagram of an illustrative communication network suited for incorporation of an embodiment of the present invention.

FIG. 2 is a block diagram of an exemplary switch such as shown in FIG. 1.

FIGS. 3 and 4 together form a flow diagram of an illustrative embodiment of a method in accordance with the present invention.

### DETAILED DESCRIPTION

One aspect of the present invention resides in the recognition that known approaches for providing remediation services are not scalable. That is, each client that is to receive remediation services must be individually identified by a switch providing management of the remediation services so that adding clients to receive remediation services causes a proportional increase in computational loading and in memory resources used by the switch to store individual client identities. The ability to apply a single label to a group of clients needing remediation services enables the switch to recognize these individual clients based on the single group label and provides a scalable solution that minimizes the resources and processing required by the switch in providing remediation management.

Another aspect of the present invention resides in the automated redirection of the client to the remediation server, where known prior approaches have not provided this capability. A further aspect of the present invention resides in automatically informing the client that the client has been quarantined.

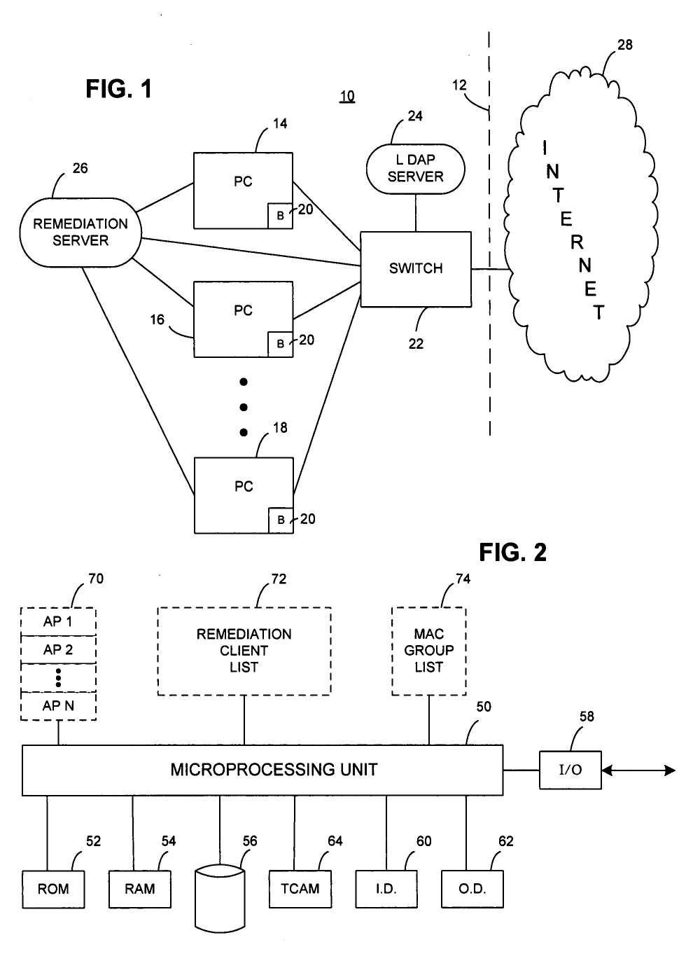

FIG. 1 shows an exemplary block diagram of a subgroup 10 to the left of dashed line 12. A plurality of communication terminals 14, 16 and 18, which are personal computers (PC) in this example, support respective users that are members of the subgroup 10. Each of the communication terminals include a browser 20 which together with a network interface facilitates TCP/IP communications. Those skilled in the art will appreciate that the communication terminals may comprise different types of wired and wireless communication devices. A network switch 22 is coupled to the communication terminals and provides a gateway for communications between each of the communication terminals and other devices, which may comprise other communication terminals, servers within the subgroup and/or devices accessed via the Internet 28. The subgroup includes a lightweight directory access protocol (LDAP) server 24 connected to the switch 22. The subgroup also includes a remediation server 26 that is coupled to the switch 22 and is also accessible by the telecommunication terminals. The utilization and interaction of these described elements will be explained in greater detail below as part of an explanation of exemplary embodiments of methods in accordance with the present invention.

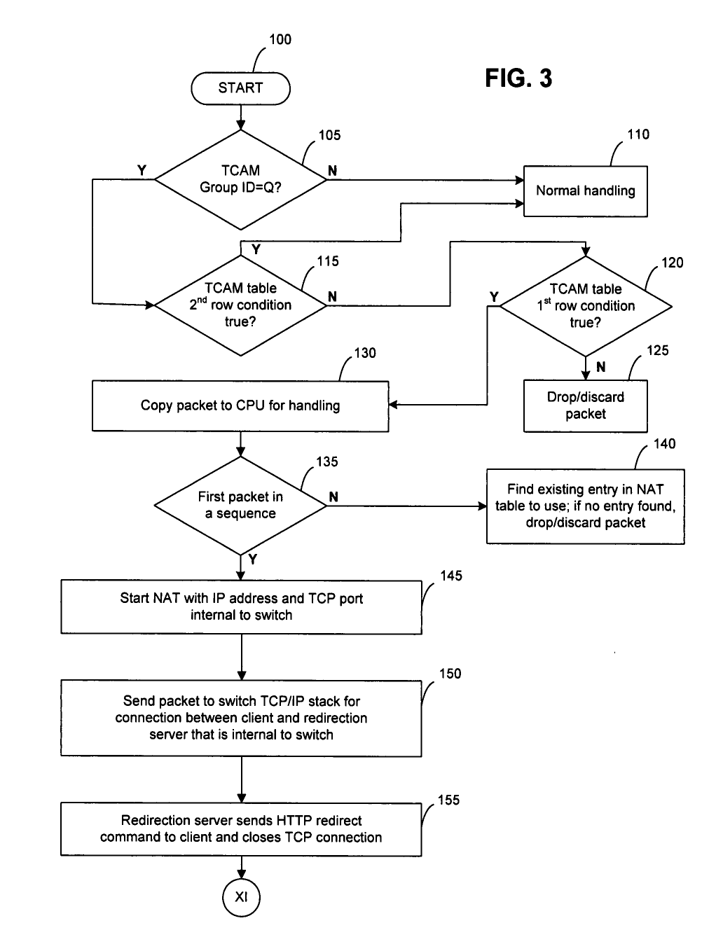

FIG. 2 is a block diagram of an exemplary switch 22 that can be used in the network of FIG. 1. A microprocessing unit (microprocessor) 50 is supported by read-only memory (ROM) 52, random access memory (RAM) 54, and nonvolatile data storage device 56 which may be a hard drive. An input/output module 58 is coupled to the microprocessor 50 and supports inbound and outbound communications with external devices. Input devices (I.D.) 60 such as a keyboard or mouse permit an administrator to provide data and inputs to the microprocessor and programs running on it. Output generated by the microprocessor can be displayed to the administrator by an output device (O.D.) 62 such as a monitor. Program instructions initially stored in ROM 52 and storage device 56 are typically transferred into RAM 54 to facilitate run-time operation of the application(s) implemented by microprocessor 50.

A ternary content addressable memory (TCAM) 64 is coupled to the microprocessor 50 and provides a special type of memory operation. With a normal computer memory such as RAM, an operating system provides an address and receives the data stored at the supplied address in return. With content addressable memory, the operating system supplies the data and in return receives a list of addresses where the data is stored, if it finds any. It generally searches the entire memory in one operation and is hence faster than conventional RAM. A ternary type of CAM allows an input request to match a third state, where the third state may comprise a mask, i.e. may have any desired value/content such as a single common label as described below. The functioning of the switch 22 will be described in greater detail below with regard to the exemplary methods.

The elements in FIG. 2 shown in dashed line format above the microprocessing unit 50 represent functional aspects associated with the operation of the switch 22. The microprocessing unit 50 in corporation with its supporting elements may implement a plurality of application programs (AP) 70 that are used to facilitate management of the remediation services provided to the clients, i.e. PCs 14, 16 and 18. An exemplary table 72 may contain a list of individual clients that have been determined to require remediation services. Another exemplary table 74, which may be used as a layer two (L2) switching table, contains a listing of the media access control (MAC) addresses of the clients that can originate traffic and includes a single common group label that is associated with those clients that require remediation services. The tables 72 and 74 may be stored in RAM 54 and/or storage device 56.

A general overview will be helpful in understanding the detailed description of an exemplary embodiment of a method in accordance with the present invention. A list of pre-identified clients requiring remediation services identifies these clients by MAC address. Each of these identified clients are assigned a common group label, i.e. a quarantine group label “Q”. Members of the quarantine group are prevented from accessing network resources except for a predefined remediation server or remediation web site. When a member of the quarantine group attempts to access another web service, the traffic is intercepted by the switch which causes an HTTP redirect command to be sent to the PC of the originating member. The redirect command causes the client browser of the member's PC to access a predefined remediation web site/server. The member can then receive appropriate remediation services, such as by taking actions to neutralize a virus affecting the member's PC or downloading software patches required to update programs residing on the member's PC. Preferably the remediation web site/server causes the client's PC to display an explanation of why the client is being redirected to the remediation site and instructions of how to proceed with the remediation action, if any manual intervention by the client is needed. Following the successful completion of the remediation, the quarantine group label is removed from association with the MAC address of the member thereby restoring general network access for the member, i.e. subsequent traffic initiated by the member's PC will be normally routed (or bridged) to the intended destination. This mechanism informs the client that it has been quarantined and permits the client to complete remediation services without requiring a manual assistance or intervention by an administrator.

The below exemplary L2 Table, which may be represented by the MAC group list table 74 in FIG. 2, illustrates the use of a group label that can be associated with selected clients identified by MAC address. In the first row, a source MAC address is associated with port 1/1 and has an assigned group identification of “Q”, representing that this client is part the Quarantine group that requires remediation services. In the second row, another source MAC address is associated with port 1/2 and has an assigned group identification of “0” (zero or null), representing that this client is not part of the quarantine group. The L2 Table will contain an entry for each client's MAC address that sources traffic. Upon the occurrence of a new client having a new MAC address originating traffic to be handled by the switch, this table will be updated to include the client's MAC address, the associated port number, and will by default assign a group ID of 0. The group ID of a client is changed to Q only upon a determination being made that this client requires remediation services. A known intrusion detection system software or other known application can be used to generate the list of clients that require remediation services. This list can be stored in a table at the LDAP server 24, periodically downloaded by the switch, and stored as table 72.

L2 Table

| | | |
|---|---|---|
| SRC MAC 00:00:00:00:00:01 | Port 1/1 | group ID = Q |
| SRC MAC 00:00:00:00:00:02 | Port 1/2 | group ID = 0 |
| . . . | . . . | . . . |

The following table showing TCAM packet handling for client origination requests will be helpful in understanding the exemplary method that follows. In this example, the TCAM 64 has responsibility for handling ingress packets from clients. The three rows in this table illustrate how the TCAM will handle packets that originate from a client needing remediation services, i.e. Group ID=Q, based on the three specified conditions. A packet originating from a client that does not require remediation services, i.e. Group ID=0, will be handled in a conventional manner, e.g. where the TCAM permits the packet(s) to be directed toward the port/node as determined by a forwarding engine, i.e. the TCAM will not overwrite the forwarding decisions made by the forwarding engine. The TCAM packet handling table will be further explained in connection with the exemplary method.

TCAM packet handling instructions

| | | |
|---|---|---|
| Group ID = Q | TCP port = HTTP | Action: copy to CPU |
| | | for handling |
| Group ID = Q | destination = remediation server, | Action: ALLOW |
| | DNS server or DHCP server | |
| Group ID = Q | not matching either of above | Action: DROP |
| | two conditions | |

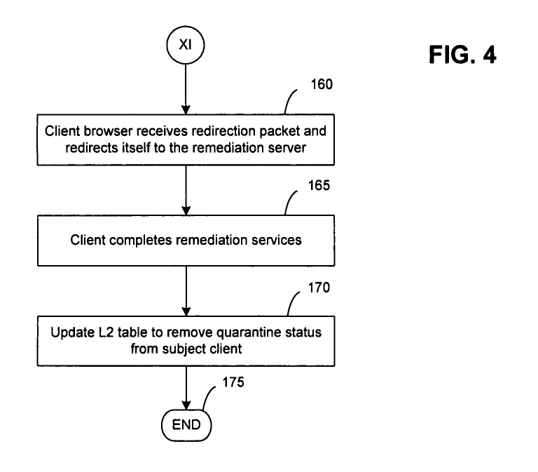

FIGS. 3 and 4 illustrate steps in an exemplary method in which many of the steps are implemented by or caused to be implemented by a switch such as switch 22 in FIG. 1. The method begins with START 100. In step 105 a determination is made of whether an incoming (ingress) packet from a served client is determined by the TCAM to have a group identification indicating that remediation services is required, e.g. Group ID=Q. A NO determination by step 105, indicating that remediation services are not required, results in normal handling of the packet, e.g. routing to a port/node associated with the destination of the packet, as indicated in step 110. A YES determination by step 105, indicating that remediation services are required, results in a further determination by the TCAM in step 115 of whether the condition of row two in the TCAM table is true, i.e. whether the indicated destination is one of a remediation server, DNS server or DHCP server. A NO determination by step 115 results in a further determination in step 120 by the TCAM of whether the condition of row one in the TCAM table is true, i.e. whether an HTTP request is present. A NO determination my step 120 results in the subject packet being dropped or discarded in step 125. This effectively limits the ability of a client identified as requiring remediation services to communications associated with the implementation of the remediation services. A YES determination by step 115 results in the packet being allowed to complete in a normal manner as indicated in step 110, because the packet request only desires services from a DNS or DHCP server, or the remediation server itself. It will be understood that other services could also be included to be treated as per step 110, e.g. ARP requests and replies.

A YES determination by step 120, indicating that the subject packet is not destined to the remediation server and is an HTTP packet, results in the TCAM copying/transferring the packet to the microprocessing unit of the switch for handling as indicated in step 130. In step 135 a determination is made by the switch of whether the subject packet is the first packet in a sequence, e.g. whether an originating SYN flag in a TCP connection is set. A NO determination by step 135 results in an existing entry from a NAT table being used. If there is no existing entry in the NAT table, the packet is dropped/discarded. Every packet between the client and the switch needs to be NAT-ed in and out, till the TCP connection is closed by the remediation server. A YES determination by step 135 starts a network address translation (NAT) process of the destination IP address in which an entry is created in the NAT table and a TCP port address that is internal to the switch in step 145, and saves this information to be used by the reverse traffic as well as subsequent packets of this stream. In step 150 the switch sends this NAT'ed packet to its TCP/IP processing stack for connection between the client and an internally implemented redirection server at the TCP port that is internal to the switch. In step 155 the redirection server sends an HTTP redirect command, e.g. HTTP redirect code 301, to the client, which is reverse NAT'ed to the client using the saved information of step 145, and closes the TCP connection with the redirection server. Alternatively, if a remediation server is not available or has not yet been configured to provide the required remediation services, the redirection server can provide a web page to the client indicating the quarantine status of the client prior to closing the connection.

In step 160 the browser of the client's PC receives the redirection packet from the switch, spoofed (by virtue of the NAT process) as being from the original destination of the HTTP request, and redirects itself to the remediation server. It will be noted that the TCAM will allow access by the client's PC to the remediation server in accordance with the condition in row two in the TCAM table. In step 165 the client has completed the implementation of the required remediation services, e.g. virus detection and eradication, or download of a software update. Depending upon the nature of the remediation services required, the remediation process may be completed without any manual intervention or input from the client. In step 170 the L2 table is updated following the client's completion of the remediation process to remove the subject client from quarantine status. Following the updating of the L2 table, the group label will not show the subject client as requiring remediation services and will therefore cause the TCAM and the microprocessor of the switch to route packets originated by the client in a normal manner toward the intended destination.

Although exemplary implementations of the invention have been depicted and described in detail herein, it will be apparent to those skilled in the art that various modifications, additions, substitutions, and the like can be made without departing from the spirit of the invention. For example, a TCAM is not a requirement for practicing an embodiments of the present invention. Any architecture that is capable of identifying a single label applicable to a plurity of clients could be utilized. The functionality of the elements of FIG. 1 could, depending upon the system design architecture, be implemented in other elements or integrated into fewer elements. For example, a single node could be designed to implement the functionality of switch 22, LDAP server 24 and the remediation server 26.

The scope of the invention is defined in the following claims.

We claim:

1. A method for directing client devices in a computing network to a remediation node comprising the steps of:
identifying a subset of the client devices to receive remediation services with a single common label;
determining if one of the client devices that originates a communication request packet is identified by the single common label;
upon determining that said one is identified by the single common label, processing its communication request packet as follows:
directing the communication request packet to a redirection server;
transmitting from the redirection server to the one a hypertext transfer protocol (HTTP) command specifying that the one client device redirect communications to the remediation node so that remediation services can be supplied to the one client device via the remediation node.

2. The method of claim 1 wherein the step of identifying comprises assigning the single common label as part of identification of each of the subset clients in a ternary content addressable memory (TCAM).

3. The method of claim 2 wherein the identification of each of the subset clients also comprises an address unique to each of the subset client devices, where the address is one of a media access control (MAC) address of the client, an actual physical port address associated with the client, and an IP address of the client.

4. The method of claim 2 wherein the step of determining if the one is identified by the single common label comprises using the TCAM to determine if the address associated with the one contains the single common label.

5. The method of claim 1 wherein the step of directing comprises performing a network address translation (NAT) between an address of a destination of the communication request packet and an address of a redirection server so that the communication request packet is forwarded to the redirection server.

6. The method of claim 5 further comprising transmitting from the redirection server to the client device a command instructing the client device to redirect its communication request, via NAT spoofing the original destination from the communication request packet of the client, to the remediation node, the latter's address contained with the transmission of the command.

7. The method of claim 6 further comprising transmitting a further communication request from the client device to the remediation node upon receipt of the command, and receiving indicia at the client device from the remediation node indicating the remediation services are required for the client device.

8. The method of claim 7 further comprising engaging in communications with the remediation node by the client device in order to implement the remediation services.

9. The method of claim 8 further comprising completing implementation of remediation associated with the remediation services by the client device, and updating a listing of said subset of the client devices by deleting identification of the one client device with the single common label so that the one client device upon generating origination of another communication request packet will not be determined to be identified by the single common label, thereby permitting routing of the another communication request packet to its intended destination.

10. A switch for directing client devices in a computing network to a remediation node comprising:
microprocessing unit supported means for identifying a subset of the client devices to receive remediation services with a single common label;
microprocessing unit supported means for determining if one of the client devices that originates a communication request packet is identified by the single common label;
upon microprocessing unit supported determining means determining that said one is identified by the single common label, a microprocessing unit supported means for processing the communication request packet so that:
the communication request packet is directed to a redirection server, and
a hypertext transfer protocol (HTTP) command is transmitted from the redirection server to the one, where the HTTP command specifies that the one client device redirect communications to the remediation node so that remediation services can be supplied to the one client device via the remediation node.

11. The switch of claim 10 wherein the microprocessing unit supported means for identifying comprises a microprocessing unit supported means for assigning the single common label as part of identification of each of the subset clients in a ternary content addressable memory (TCAM).

12. The switch of claim 11 wherein each of the subset clients also has an associated address unique to each of the subset client devices, where the address is one of a media access control (MAC) address of the client, an actual physical port address associated with the client, and an IP address of the client.

13. The switch of claim 11 wherein the microprocessing unit supported means for determining comprises the TCAM determining if the address associated with the one contains the single common label.

14. The switch of claim 10 wherein the microprocessing unit supported means for processing comprises microprocessing unit supported means for performing a network address translation (NAT) between an address of a destination of the communication request packet and an address of a redirection server so that the communication request packet is forwarded to the redirection server.

15. The switch of claim 14 further comprising microprocessing unit supported means for transmitting from the redirection server to the client device a command instructing the client device to redirect its communication request to the remediation node, the latter's address contained with the transmission of the command.

16. The switch of claim 15 the command is designed to be acted upon by the client device to cause the latter to transmit a further communication request to the remediation node upon receipt of the command and to cause the client device to engage in communications with the remediation node in order to implement the remediation services.

17. The switch of claim 16 further comprising microprocessing unit supported means for updating a listing of said subset of the client devices by deleting identification of the one client device with the single common label upon the client device having completed implementation of remediation associated with the remediation services, thereby causing the switch to route another communication request packet from the one client device to its intended destination.
